(19) United States
(12) Patent Application Publication
(10) Pub. No.: US 2023/0265292 A1
(43) Pub. Date: Aug. 24, 2023

(54) RESTORATION PRESERVATION AND PROTECTION MUD FOR WOOD AND CONCRETE

(71) Applicant: Steve Alpert, Honolulu, HI (US)

(72) Inventor: Steve Alpert, Honolulu, HI (US)

(21) Appl. No.: 17/680,196

(22) Filed: Feb. 24, 2022

(51) Int. Cl. C09D 5/02; C09D 15/00; C09D 7/65; C09D 7/61; C09D 7/43; C04B 41/00; C04B 41/50; C04B 41/48; C04B 41/45; C04B 41/68; C04B 41/63; B05D 7/06

(52) U.S. Cl. CPC C09D 5/028; C09D 15/00; C09D 5/022; C09D 7/65; C09D 7/61; C09D 7/43; C04B 41/009; C04B 41/5024; C04B 41/48; C04B 41/4539; C04B 41/68; C04B 41/63; B05D 7/06

(57) ABSTRACT

A method for treating wood, is disclosed. The method includes developing a mud composite. The mud composite includes four parts mud. The mud composite includes three parts binder. The method includes mixing the mud composite until it reaches a creamy consistency. The method includes applying the mud composite to a wood fixture.

### FIELD OF THE INVENTION

This disclosure relates to a novel method of improving the surface of wood or timber. Specifically, the disclosure relates to the restoration, preservation, and protection of wood products in adverse environments.

### BACKGROUND

Many structures such as fencing, walls, and wood-based structures made from timber are often exposed to natural environments that are susceptible to damage from natural causes. These natural causes can be selected from one or more of the sun, wind, rain, hail, snow, fungi, molds, mildews, insects and other biodegrading agents. This is especially noticeable in environments that have warmer temperatures and a higher humidity.

Often these wood surfaces are treated with various chemicals, preservation coatings, and other products that used to treat biodegrading agents, and preserve the wood from fading, and breaking down. Often these products are capable of being used even without paint protection. These products are often wood products that cause many types of wood to be protected from the attack of decay fungi, harmful insects, or marine borers by applying chemical preservatives. Preservative treatments greatly increase the life of wood structures, thus reducing replacement costs and allowing more efficient use of forest resources.

Wood preservative treatments often absorb large amounts of water and moisture during the life span of the wood. Accordingly, there ca be a significant amount of swelling and shrinking stress in the wood that are often attributable to the season and climate changes in a natural environment. The swelling and shrinking that can take place seasonally, can cause the wood to change dimensional shape, develop a significant amount of surface cracks, lose the required mechanical properties, and rot.

Embodiments of the invention, on the other hand, provide significant advantages while overcoming the above-described and other disadvantages, as will now be described.

### SUMMARY

In order to address many of the above challenges and problems, a method for treating wood, is disclosed. The method includes developing a mud composite. The mud composite includes four parts mud. The mud composite includes three parts binder. The method includes mixing the mud composite until it reaches a creamy consistency. The method includes applying the mud composite to a wood fixture.

In one embodiment, the mud composite is configured to fill, seal and protect a wood fixture.

In one embodiment, the mud composite is configured to repair wood rot, water damage and wood pest damage.

In one embodiment, the mud composite comprises of a base and a binder.

In one embodiment, the base is an eggshell sheen paint blend.

In one embodiment, the binder is a wood glue.

In one embodiment, the binder is configured to be tinted slightly with concrete.

In one embodiment, the base is a pre-tinted exterior grade.

In one embodiment, the base comprises a satin paint, and a flat paint, that when mixed results in an exterior grade eggshell sheen.

In one embodiment, the method further comprises moistening the wood.

In one embodiment, the step of applying the mud composite to a wood fixture is completed with one or more of a spatula, a putty knife, or a flat edge tool.

Another embodiment of the invention includes mud composite for repairing a defect in a concrete finished surface. The mud composite includes three parts of a glue composite, four parts of a paint composite, at least one part of a paint thickener, and at least one part of one or more pigment additives. Each of the glue composite, the paint composite, the paint thickener, and the one or more pigment additives are mixed and applied to the concrete finish surface. Accordingly, upon drying of the mud composite a plurality of disjointed area of the concrete finished surface are bonded.

In one embodiment, a consistency of the mud composite comprises of a crunchy and thick consistency, wherein the crunchy and thick consistency is configured to join the plurality of disjointed areas with a same consistency of the concreate finished surface.

In one embodiment, the mud composite is configured to fill and bridge a plurality of cracks in the concrete finished surface.

In one embodiment, the pigment additives further comprises a universal latex paint tint.

In another embodiment, a method of repairing a plurality of defects in a concrete finish surface is disclosed. The method includes mixing a compound comprising three parts of a glue composite with four parts of a paint composite. The method includes mixing at least one part of a paint thickener with the compound, wherein the paint thickener is configured to maintain a thick consistency of the compound. The method includes mixing one or more pigment components with the compound to match a predetermined color of the concrete finish surface. The method includes applying the mixture to the concrete finish surface at a first location of a defect in the plurality of defects, wherein upon the applied mixture drying, the mixture having a same hardened consistency as the concrete finish surface.

In one embodiment, the method further includes mechanically abrading the hardened mixture on the surface to conform the mixture to a surface contour.

In one embodiment, the one or more pigments are configured to form one or more colors.

In one embodiment, the method further includes selecting the pigment component to match the concrete finish surface.

In one embodiment, the drying of the applied mixture prevents water damage.

This summary is provided merely for purposes of summarizing some example embodiments, so as to provide a basic understanding of some aspects of the subject matter described herein.

Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

Disclosed herein are embodiments of an interchangeable double-sided attachment for an article. This description includes drawings, wherein:

FIG. 1 is a perspective view of imperfections in a wood substrate, in accordance with an example;

FIG. 2 is a perspective view of the imperfections of the wood substrate filled and covered by the mud composite, in accordance with an example;

FIG. 3A is a perspective view of imperfections in a concrete finish surface, in accordance with an example;

FIG. 3B is a perspective view of the imperfection covered by the mud composite, in accordance with an example;

FIG. 4 is a perspective view of the imperfections of the concrete finish surface being filled by the mud composite, in accordance with an example;

FIG. 5 depicts an exemplary process flow of the creation of the mud composite, in accordance with an example;

FIG. 6 depicts an exemplary process flow of the creation of the mud composite for concrete finish surfaces, in accordance with an example.

Elements in the figures are illustrated for simplicity and clarity and have not been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Some detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

The invention may be embodied in other specific forms without departing from the spirit of essential characteristics thereof. The present embodiments therefore to be considered in all respects as illustrative and not restrictive, the scope of the invention being indicated by the appended claims rather than by the foregoing description, and all changes which come within the meaning and range of equivalency of the claims are therefore intended to be embraced therein.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Accordingly, a method for treating wood, is disclosed. The method includes developing a mud composite. The mud composite includes four parts mud. The mud composite includes three parts binder. The method includes mixing the mud composite until it reaches a creamy consistency. The method includes applying the mud composite to a wood fixture.

The invention is a mud composite that is used to be applied to wood and concrete surfaces. The use of the substrate is advantageous as it is used in order to refinish, refurbish, and renew the wood or concrete surface, with the ability to blend in with the surrounding surface or fixture. The mud composite can also be used to cover holes, and imperfections in a dwelling finish surface, and has a pigmentation included in it that allows the mud composite to take on the color of the surrounding finish surface after drying, thereby making the spackle difficult to be noticed from the rest of the finished surface.

Adding pigment to the mud composite allows for their to be tint or coloration that is able to make the finished surface area look refinished. To make a tinted or pigmented substrate, a user begins by selecting the amount of the mud composite desired, which can be the amount needed for a particular wall, room or building. The user then selects the color of the universal tint or pigment desired for the color of the wall or walls, such as blue for white walls. A teaspoon or less of tint is added to the mud composite, and the mud composite and tint are mixed together thoroughly by a manual or mechanical means. The mixing can occur via a stir stick, rotary drill with paddle, screw driver, hand or any other suitable stirring device. The amount of tint can be adjusted according to preference. For example, for a darker color, more tint is used. It is possible to prepare the tinted mud composite in larger quantities well before it is to be used.

In preparation of applying the mud composite, the user should first prepare the mud composite through by combining a glue compound with a paint composition or coating, and a thickener in order to gain a paste-like consistency. Once the mud composite is formed, the tint is added until a desired coloration is reached that matches that of a finished surface or substrate. Once the mud composite is mixed, the mud composite is ready to be used in the conventional manner, such as by spreading using a spatula, knife or trowel.

The mud composite is prepared in order to be applied to exterior-masonry surfaces including cement, cinder block, stucco, concrete and brick. Additionally, the mud composite can be configured to also be applied to wood applications and wood fixtures as well.

The glue compound is a cross linking polyvinyl acetate that is configured create a bond on a substrate between one or more portions, or to join separated portions of the substrate. The polyvinyl acetate (PVA) is a rubbery synthetic polymer with the formula (C4H6O2)n. It also belongs to the polyvinyl esters family with the general formula [RCOOCHCH2], and can often be used as a type of thermoplastic. The glue can also include aluminum chloride, and anhydrous.

The paint composition in combination with the glue compound is able to provide structural sealing of a wood, stucco, concrete and masonry structures that may expand and contract in response to weather conditions and structural stresses. The paint composition is configured to fill and bridge cracks, as well as prevent damage to a finished surface that is often caused by water penetration. The paint composition can include one or more parts of calcium carbonate, titanium dioxide, zinc oxide, ethylene glycol, heavy paraffinic oil and benzophenone.

For the ease of understanding the present invention, below in conjunction with preferred embodiment, the present invention is made more comprehensively, meticulously to describe, but protection scope of the present invention is not limited to embodiment in detail below.

Unless otherwise defined, the implication that all technical terms used hereinafter are generally understood that with those skilled in the art Identical. Technical term used herein is intended merely to describe the purpose of specific embodiment, is not intended to limit the present invention Protection domain.

Except there being special instruction, the various reagents used in the present invention, raw material be can commodity commercially or the product that person can be obtained by known method.

A kind of present invention has early strong and bonding functionality when applied to substrates such as concrete, wood, and other masonry applications. The present disclosure is mainly by following mass parts. The component of number is formulated:

Accordingly, to create the mud composite 3 parts glue compound, 4 parts paint composition, ⅛ of a teaspoon of hydroxyethyl cellulose or thickener, and one or more combinations of pigment. The pigment can be added in stages as an added colorant or tint composition to the mud composite, until a desired color or tint consistency is met. Oftentimes the desired color or tint consistency is often staged until the mud composite matches the surrounding finished surface.

In one embodiment, in order to ensure that a bond is able to be created in wood finished surface applications, the consistency of the mud composite is configured to be creamy in nature, with a similarity to a frosting spread.

In another embodiment, to ensure that a bond is able to be created on a concreate finished surface, the consistency of the mud composite is configured as a crunchy and thick consistency. This type of consistency allows for the mud composite to be thick enough to match the rough nature that is needed to secure a concrete structure or surface.

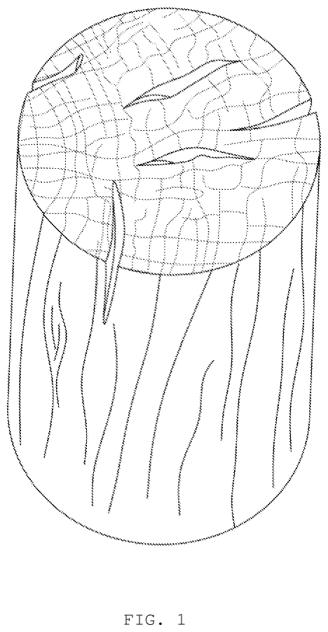

The illustration of FIG. 1 shows a wood substrate such as a wood post that is exposed to the outside elements and weather conditions. The wood substrate as shown has cracks that are needed to be filled in order to ensure that the wood substrate is able to maintain a renewed visualization as far as aesthetics is concerned, while also preventing further weather decomposition caused by water exposure.

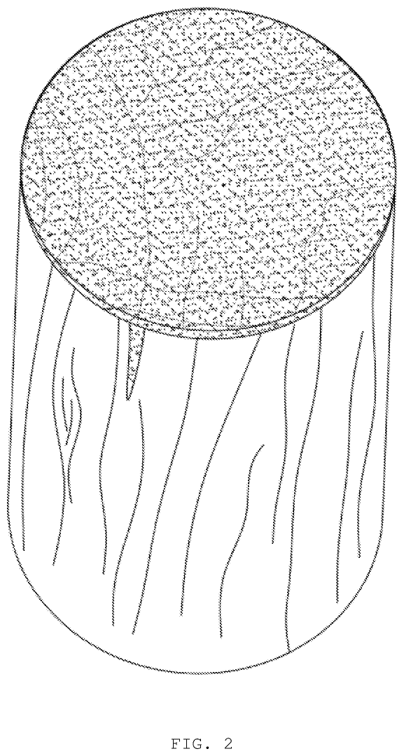

In FIG. 2, the wood substrate is then filled with the mud composite in order to repair the cracks and separation points. The mud composite as applied by one or more application means, creates a joint between at least two separated points on the wood substrate. Accordingly, the mud composite is forced into the separation points or holes identified. After application into the separation point, spread outward across the substrate surface, upon drying, the imperfection is thus made consistent with the rest of the substrate.

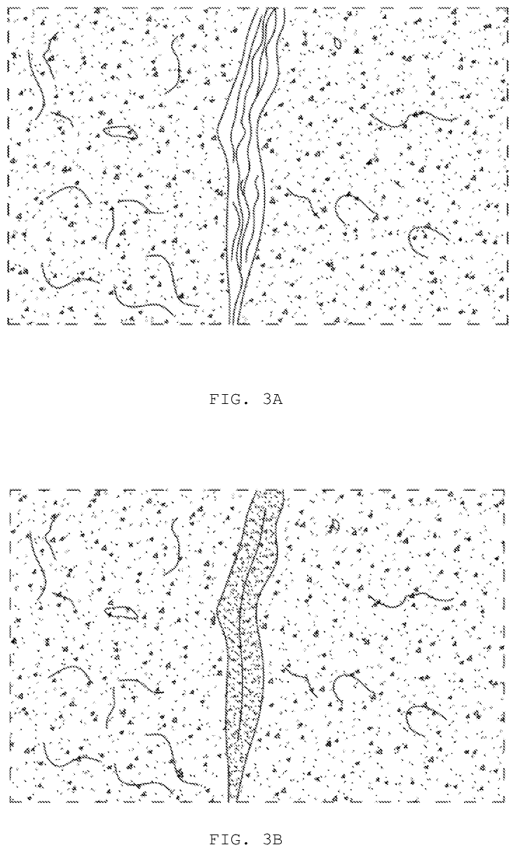

The illustration in FIG. 3A shows a concrete substrate or unfinished surface, such as a sidewalk or building wall. The separation and disjointed areas as shown in FIG. 3 indicates the weakened areas in the contrate substrate that are in need of bonding, filling, structural strengthening resulting from application of the mud composite. Accordingly, in FIG. 3B the concrete substrate is then filled with the mud composite, that upon drying causes the mud composite to become a single fluid surface where a plurality of imperfections are no longer disjointed.

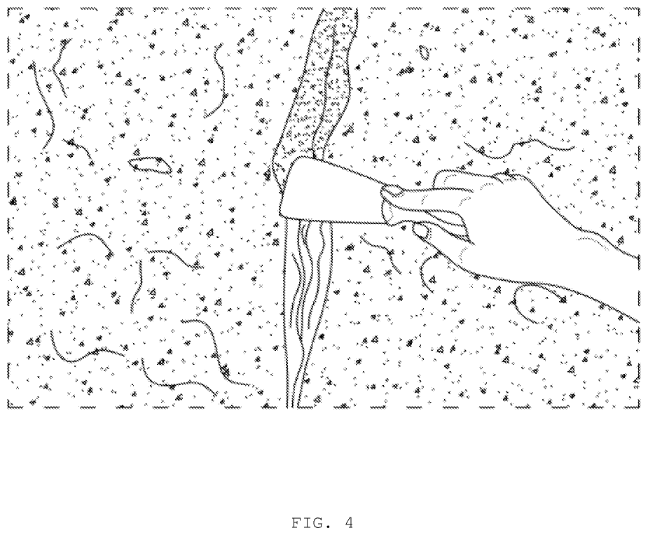

FIG. 4 illustrates the effects of when the concrete imperfections are filled with the mud composite. The mud composite is to be spread within the imperfection, and then spread across the substrate surface to make the imperfection flush with the rest of the substrate. Upon drying, the substrate, filled with the mud composite is now made consistent with the rest of the surrounding substrate surface. The dried mud composite is now not only enjoined with the surrounding substrate, and one consistent solid surface, but there is also a created overall improvement to the prevention of water damage caused by various weather conditions.

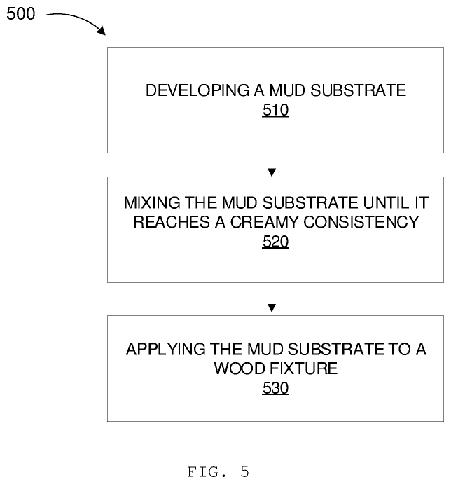

FIG. 5 depicts an exemplary process flow 500 of the creation of the mud composite, in accordance with an example. The mud composite is used to treat a wood fixture. The wood fixture can be one or more of wood posts, a wooden fence, a wooden wall, or another wood-based fixture. Each of the wood-based fixtures can be of any wood type. More specifically, the wood fixtures to be treated can be selected from one or more of pine, oak, or cedar.

In a first step, in order to treat a wood fixture, a mud composite is first developed 510. The mud composite comprises of four parts mud and three parts binder. The mud composite is configured to fill, seal and protect the wood fixture. The mud composite can further be used to be applied to the wood fixture in order to repair wood rot, water damage and wood pest damage. The mud composite can be made from a base substance and a binder substance. In an exemplary example, the base is an eggshell sheen paint blend. In some examples, the base can be a pre-tinted exterior grade. The base can also include a satin paint, and a flat paint, that when mixed results in an exterior grade eggshell sheen. In another example, the binder is a wood glue. The binder in many instances can be tinted slightly with concrete.

The mud composite is processed in a second step by mixing the mud composite until it reaches a creamy consistency 520. In order to ensure that the wood fixture is prepared to receive the mud composite and treat the wood fixture in the most efficient manner, the wood fixture can be moistened. In a third step 530, the mud composite is applied to the wood fixture. In order to effectively and smoothly apply the mud composite to the wood fixture, a spatula, a putty knife, or a flat edge tool can be used. Using any of these tools allows the operator of the tool to effectively fill all cracks, crevices, and holes in the wood fixture, to ensure they are properly treated and covered.

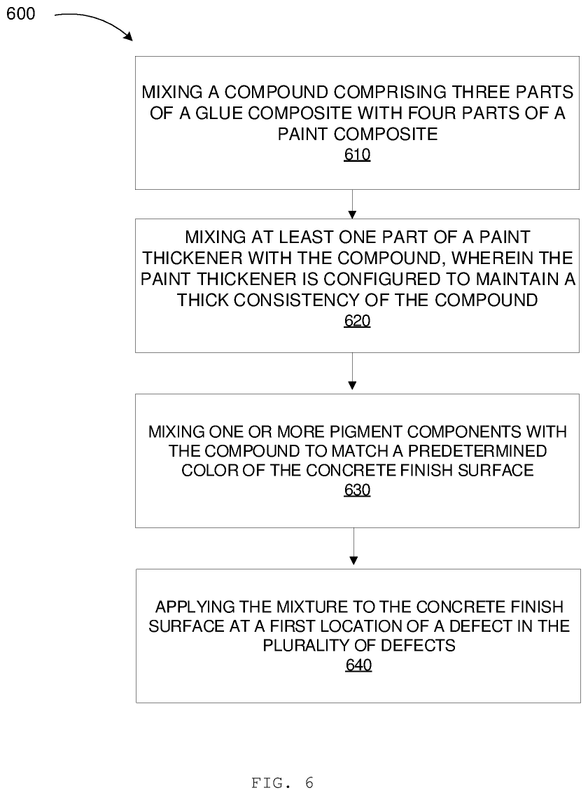

FIG. 6 depicts an exemplary process flow 600 of the creation of the mud composite for a concrete finish surface, in accordance with an example. The first step of development of the mud composite includes mixing a compound comprising three parts of a glue composite with four parts of a paint composite 610. The method includes mixing at least one part of a paint thickener with the compound, wherein the paint thickener is configured to maintain a thick consistency of the compound 620. The method includes mixing one or more pigment components with the compound to match a predetermined color of the concrete finish surface 630. The method includes applying the mixture to the concrete finish surface at a first location of a defect in the plurality of defects, wherein upon the applied mixture drying, the mixture having a same hardened consistency as the concrete finish surface 640.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

Although the present invention has been described in terms of various embodiments, it is not intended that the invention be limited to these embodiments. Modification within the spirit of the invention will be apparent to those skilled in the art.

It is additionally noted and anticipated that although the device is shown in its most simple form, various components and aspects of the device may be differently shaped or modified when forming the invention herein. As such those skilled in the art will appreciate the descriptions and depictions set forth

in this disclosure or merely meant to portray examples of preferred modes within the overall scope and intent of the invention and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the scope of the invention.

What is claimed is:

1. A method for treating wood comprising:
developing a mud composite,
wherein the mud composite comprises:
four parts mud; and
three parts binder;
mixing the mud composite until it reaches a creamy consistency; and
applying the mud composite to a wood fixture.

2. The method of claim 1, wherein the mud composite is configured to fill, seal and protect a wood fixture.

3. The method of claim 1, wherein the mud composite is configured to repair wood rot, water damage and wood pest damage.

4. The method of claim 1, wherein the mud composite comprises of a base and a binder.

5. The method of claim 4, wherein the base is an eggshell sheen paint blend.

6. The method of claim 4, wherein the binder is a wood glue.

7. The method of claim 6, wherein the binder is configured to be tinted slightly with concrete.

8. The method of claim 5, wherein the base is a pre-tinted exterior grade.

9. The method of claim 4, wherein the base comprises a satin paint, and a flat paint, that when mixed results in an exterior grade eggshell sheen.

10. The method of claim 1, further comprising moistening the wood.

11. The method of claim 1, wherein the step of applying the mud composite to a wood fixture is completed with one or more of a spatula, a putty knife, or a flat edge tool.

12. A mud composite for repairing a defect in a concrete finished surface, the mud composite comprising:
three parts of a glue composite;
four parts of a paint composite;
at least one part of a paint thickener; and
at least one part of one or more pigment additives;
wherein each of the glue composite, the paint composite, the paint thickener, and the one or more pigment additives are mixed and applied to the concrete finish surface; and
wherein upon drying of the mud composite a plurality of disjointed area of the concrete finished surface are bonded.

13. The mud composite of claim 12, wherein a consistency of the mud composite comprises of a crunchy and thick consistency, wherein the crunchy and thick consistency is configured to join the plurality of disjointed areas with a same consistency of the concreate finished surface.

14. The mud composite of claim 13, wherein the mud composite is configured to fill and bridge a plurality of cracks in the concrete finished surface.

15. The mud composite of claim 12, wherein the pigment additives further comprises a universal latex paint tint.

16. A method of repairing a plurality of defects in a concrete finish surface comprising:
mixing a compound comprising three parts of a glue composite with four parts of a paint composite;
mixing at least one part of a paint thickener with the compound, wherein the paint thickener is configured to maintain a thick consistency of the compound;
mixing one or more pigment components with the compound to match a predetermined color of the concrete finish surface; and
applying the mixture to the concrete finish surface at a first location of a defect in the plurality of defects, wherein upon the applied mixture drying, the mixture having a same hardened consistency as the concrete finish surface.

17. The method of claim 16, further comprising mechanically abrading the hardened mixture on the surface to conform the mixture to a surface contour.

18. The method of claim 16, wherein the one or more pigments are configured to form one or more colors.

19. The method of claim 16, further comprising selecting the pigment component to match the concrete finish surface.

20. The method of claim 16, wherein the drying of the applied mixture prevents water damage.
